(19) United States
(12) Patent Application Publication
(10) Pub. No.: US 2019/0176765 A1
(43) Pub. Date: Jun. 13, 2019

(54) WIPER BLADE FOR A WINDSCREEN WIPER FRAME

(71) Applicant: Valeo Systèmes d'Essuyage, Le Mesnil Saint Denis (FR)

(72) Inventor: Patrick Assuid, Issoire (FR)

(73) Assignee: Valeo Systèmes d'Essuyage, Le Mesnil Saint Denis (FR)

(21) Appl. No.: 16/301,043

(22) PCT Filed: May 12, 2017
(86) PCT No.: PCT/EP2017/061534

§ 371 Date: Nov. 13, 2018

(30) Foreign Application Priority Data
May 13, 2016 (FR) 1654299

(51) Int. Cl. B60S 1/38

(52) U.S. Cl. CPC B60S 1/38; C08L 7/00

(57) ABSTRACT

The invention concerns a wiper blade (1) for a windscreen wiper frame, at feast a portion of said blade (1) comprising a material made from natural rubber and at least one additive, characterised in that said additive is at least a bio-sourced plasticiser and in that said blade comprises, as the only rubber, said natural rubber in the vulcanised state, said vulcanised rubber being obtained by vulcanising a non-functionalised natural rubber. The invention also concerns a windscreen wiper frame comprising such a wiper blade and a wiper system comprising such a windscreen wiper frame.

### FIELD OF THE INVENTION

The present invention relates to a wiper blade for a windshield wiper, notably a wiper blade made of material of biosourced origin.

### PRIOR ART

Motor vehicles are commonly equipped with windshield wiper systems to provide washing and/or wiping of the windshield and to avoid disturbing the driver's view of his environment. The wiper blades of such a system are conventionally driven by arms performing a reciprocating angular motion. These blades rub against the outside surface of the glass, for example the windshield, and remove the water, moving it outside of the driver's field of view. In a conventional version, the wipers are made in the form of hinged arms that hold the wiper blade at several points. In a more recent version called “flat blade”, the wipers are made in the form of a semirigid assembly that holds the wiper blade on its entire length.

In general, a wiper blade is made of elastically deformable material based on an elastomer supplemented with additives, notably to improve its mechanical properties, elasticity, wear resistance, resistance to external aggressive factors or else to facilitate implementation of the manufacturing process. These may be for example reinforcing fillers, plasticizer, vulcanizing agent, agents for protection against UV radiation, oxidation, ozone and/or wear.

Both the elastomer and the additives are in most cases products from the petrochemical industry. However, increasing concern about preserving the environment and reducing CO₂ emissions is tending to limit the use of such products from the petrochemical industry.

In the rubber industry, it is possible to use natural rubber as the basic elastomer, which has excellent performance from the standpoint of its elasticity and its intrinsic mechanical properties. Natural rubber is a product from rubber tree cultivation, and therefore it is a biosourced material.

However, the elastomer/additives ratio in the end product is generally of the order of 50%-50% by weight and the level of products not obtained from petrochemistry is in the end rather low. These additives are still necessary for obtaining a material having adequate properties, notably in terms of mechanical strength, and sliding properties without generating excessive noise so as to be usable in the automobile industry for manufacturing wiper blades. Moreover, the current solutions commonly use rubbers that have been functionalized upstream of the rubber vulcanizing and curing operations, which makes the wiper blade manufacturing process longer and more complicated.

There is therefore a need for a wiper blade made wholly or partly of a material that does not have these drawbacks.

### SUMMARY OF THE INVENTION

For this purpose, the invention proposes a wiper blade for a windshield wiper, with at least part of said blade comprising a material based on natural rubber and at least one additive, characterized in that said additive is at least one biosourced plasticizer and in that said blade comprises, as the only rubber, said natural rubber in the vulcanized state, said vulcanized rubber being obtained by vulcanization of a nonfunctionalized natural rubber.

In the sense of the present invention, the term “biosourced” denotes a product that is not of fossil origin and in particular a product of vegetable, animal or mineral origin. “Of fossil origin” means any product obtained from oil or coal or from derivatives of oil or coal, notably the products from the petrochemical industry.

The use of biosourced products as plasticizers makes it possible to improve the properties of natural rubber while increasing the proportion of biosourced products in the material. Plasticizers notably make the material easier to handle and facilitate its application in an industrial manufacturing process.

In the sense of the present invention, the term “nonfunctionalized” must be understood as meaning that the polymer chains that form said natural rubber have not been modified chemically by adding chemical functions or functional groups covalently to said polymer chains.

However, the natural rubber used in the present invention may, before the vulcanizing and curing operations, undergo one or more purification steps with the aim of removing the organic (notably vegetable) and mineral impurities from the natural rubber, which for the most part are derived from the plant sap from which said natural rubber is obtained.

According to the invention, the use of nonfunctionalized natural rubber as the only rubber of the wiper blade, in combination with a biosourced plasticizer, makes it possible to obtain a wiper blade that is more environmentally friendly, easier to manufacture, and whose mechanical and physical properties are suitable for wiping a motor vehicle window glass.

Thus, the invention makes it possible to obtain a wiper blade with suitable mechanical and physical properties, without having to have recourse to a mixture of natural and synthetic rubbers for its manufacture, or having recourse—prior to vulcanization and curing of the rubber—to functionalization treatments of the rubber or rubbers used for forming the wiper blade.

According to various embodiments of the invention, which can be implemented together or separately:

said blade comprises a single grade of natural rubber, for example rubber TSR 10 or 20, preferably rubber TSR 20,

the plasticizer is a biosourced oil,

the difference between the solubility parameter of said biosourced oil and the solubility parameter of said natural rubber, measured in (cal/cm³)^{1/2}, is less than or equal to 2 (cal/cm³)^{1/2}, or even less than or equal to 1.5 (cal/cm³)^{1/2}, or even less than or equal to 1 (cal/cm³)^{1/2}, or even less than or equal to 0.5 (cal/cm³)^{1/2},

the solubility parameter of said biosourced oil is close to the solubility parameter of said natural rubber,

the solubility parameter of said biosourced oil is between 7 and 10 (cal/cm³)^{1/2}, preferably between 8 and 9 (cal/cm³)^{1/2},

said biosourced oil is selected from vegetable oils and/or fats, animal oils and/or fats, or a mixture thereof,

said biosourced oil is selected from sunflower oil, olive oil, colza oil, linseed oil, coconut oil, castor oil, soybean oil, preferably a mixture of sunflower oil and colza oil,

said wiper blade comprises, as the only oil, said sunflower oil,

said oil is selected from fish oils,

said additive is moreover a biosourced reinforcing filler,

said biosourced reinforcing filler is selected from a mineral filler, wood fibers, cellulose, diatoms, or a mixture thereof, preferably a mixture of mineral filler and wood fibers,

said mineral filler is an aluminum silicate, such as a kaolin,

more than 90 wt % of said material is of biosourced origin, preferably more than 95 wt %, or even more than 96 wt %,

less than 10 wt % of said material is of nonbiosourced origin, preferably less than 5 wt %, or even less than 4 wt %,

said blade part comprising said material is a basic body of said blade,

said additive is a biosourced protective agent against UV radiation,

said protective agent is a metal oxide selected from titanium dioxide, zinc oxide, or a mixture thereof,

said additive is a nonbiosourced antioxidant,

said antioxidant is selected from diphenyl amines, paraphenylenediamines, or a mixture thereof,

said additive is a nonbiosourced vulcanizing agent,

said vulcanizing agent is selected from thiuram, thiazole, sulfenamide, or a mixture thereof, preferably a mixture of thiuram, thiazole and sulfenamide.

The invention also relates to a windshield wiper comprising a wiper blade according to the invention.

The invention finally relates to a wiping system comprising a windshield wiper according to the invention.

### DESCRIPTION OF THE FIGURES

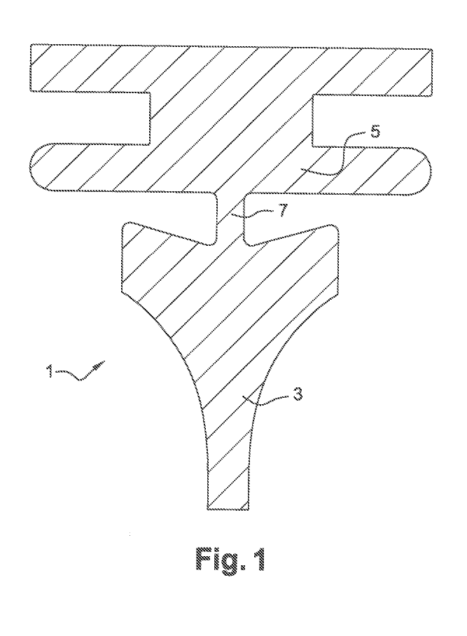

The invention will be better understood, and other aims, details, features and advantages of the invention will become clearer from the detailed explanatory description given hereunder, of at least one embodiment of the invention given as a purely illustrative and nonlimiting example, referring to the appended FIG. 1, which is a schematic sectional view of a wiper blade according to one embodiment of the invention.

### DETAILED DESCRIPTION

The wiper blade 1 according to the invention comprises a material based on:

natural rubber, and

at least one additive.

The additive is for example a biosourced plasticizer.

A plasticizer is a component for making the material more flexible and/or easier to use for manufacturing a wiper blade. Generally, piasticizers are often oils. Here, according to the invention, the plasticizer is a biosourced oil.

The biosourced oil is selected so that the difference between the solubility parameter of the biosourced oil measured in (cal/cm³)^{1/2} and the solubility parameter of natural rubber is less than or equal to 2 (cal/cm³)^{1/2}, or even less than or equal to 1.5 (cal/cm³)^{1/2}, or even less than or equal to 1 (cal/cm³)^{1/2}, or even less than or equal to 0.5 (cal/cm³)^{1/2}.

The solubility parameter of natural rubber is 8.3 (cal/cm³)^{1/2}.

In other words, the solubility parameter of the biosourced oil is close to the solubility parameter of natural rubber. This ensures that the biosourced oil (or a mixture of biosourced oils) selected is compatible with and has good affinity for natural rubber, i.e. the oil will mix properly with natural rubber.

Thus, the solubility parameter of the biosourced oil is between 7 and 10 (cal/cm³)^{1/2}, and preferably between 8 and 9 (cal/cm³)^{1/2}.

The biosourced oil is for example selected from vegetable oils and/or fats but also from animal oils and/or fats, or a mixture thereof.

Advantageously the vegetable oil and/or fat is selected from sunflower oil, olive oil, colza oil, linseed oil, coconut oil, castor oil, soybean oil. Preferably, it is a mixture of sunflower oil and colza oil.

The animal oil and/or fat is selected from fish oils.

These biosourced oils are known to have a solubility parameter between 8.2 and 8.4 (cal/cm³)^{1/2}. As examples, solubility parameters for a selection of oils are given in the following table:

| | |
|---|---|
| sunflower oil | 8.2 (cal/cm³)^{1/2} |
| olive oil | 8.4 (cal/cm³)^{1/2} |
| colza oil | 8.3 (cal/cm³)^{1/2} |
| linseed oil | 8.4 (cal/cm³)^{1/2} |
| coconut oil | 8.4 (cal/cm³)^{1/2} |

According to the invention, the use of nonfunctionalized natural rubber as the only rubber of the wiper blade, in combination with one or more biosourced oils that have a solubility parameter between 8.2 and 8.4 (cal/cm³)^{1/2}, makes it possible to obtain a wiper blade that is environmentally friendly, easy to manufacture, and whose mechanical and physical properties are very suitable for wiping a motor vehicle window glass.

Preferably, the material further comprises a biosourced reinforcing filler as an additive.

The reinforcing filler makes it possible to improve the mechanical properties of the rubber. Notably it makes it possible to improve the breaking strength and/or abrasion performance of the wiper blade 1.

The biosourced reinforcing filler is for example selected from a mineral filler, wood fibers, cellulose, diatoms, or a mixture thereof. Preferably, it is a mixture of mineral filler and wood fibers.

These types of reinforcing fillers make it possible to improve the mechanical properties of natural rubber, while limiting the use of carbon black of nonbiosourced origin that is used conventionally as a reinforcing filler of elastomers in the motor vehicle sector.

The mineral filler is preferably an aluminum silicate, such as a kaolin. Kaolin means a mineral species rich in aluminum silicates, in particular rich in hydrated aluminum silicates such as kaolinite. It may also be calcined kaolin.

Advantageously, the material comprises:

between 30 and 45 wt % of natural rubber, preferably between 35 and 40 wt %,

between 35 and 55 wt % of biosourced reinforcing filler, preferably between 40 and 50 wt %, and

between 1 and 10 wt % of biosourced plasticizer, preferably between 4 and 7 wt %.

The material may also comprise one or more additives that are generally known by a person skilled in the art, notably for improving the mechanical properties, elasticity, wear resistance, resistance to external aggressive factors or else to improve the implementation of the method.

It may be a vulcanizing agent, or a protective agent against UV radiation, oxidation, ozone and/or wear, for example. The additives are of biosourced origin so that more than 90 wt % of the material is of biosourced origin, preferably more than 95 wt %, or even more than 96 wt %.

In other words, less than 10 wt % of the material is of nonbiosourced origin, preferably less than 5 wt %, or even less than 4 wt %.

Advantageously, the “nonbiosourced” products are products of fossil origin, notably from petrochemistry.

Thus, the material comprises as additive at least one biosourced protective agent against UV radiation. This protective agent is, for example, a metal oxide selected from titanium dioxide, zinc oxide, or a mixture thereof.

The metal oxide may be combined with an acid, such as stearic acid and/or palmitic acid. On reacting with the metal oxide, the acid forms a salt that makes it possible to dissolve the metal oxide in the mixture.

The material further comprises nonbiosourced additives. They may be at least one nonbiosourced antioxidant and/or at least one nonbiosourced vulcanizing agent.

The antioxidant is selected, for example, from diphenyl amines, paraphenylenediamines, or a mixture thereof.

The vulcanizing agent is selected, for example, from thiuram, thiazole, sulfenamide, or a mixture thereof. Preferably, it is a mixture of thiuram, thiazole and sulfenamide. Any other antioxidant and/or any other vulcanizing agent known by a person skilled in the art may be envisaged.

According to FIG. 1, the wiper blade 1 of a windshield wiper according to the invention has an elongated shape and is intended to be carried by a body of the wiper (not shown). The blade 1 comprises a lip 3 and a heel 5, which are connected by a hinge 7. Together, the lip 3, heel 5, and hinge 7 form a basic body of the blade 1.

The heel 5 makes it possible to hook the blade 1 in the body of the wiper. The lip 3 is intended to be in contact with the outside surface of a window glass such as a windshield, for wiping it.

The hinge 7 is formed by a thin strip of material, which gives the blade some flexibility and allows the latter to flip over during a change in direction of movement of the wiper, in other words the lip has a movement of flipping to and fro.

The blade 1 is obtained by a conventional method of manufacture known by a person skilled in the art.

Advantageously, at least part of the blade 1 comprises the material as described above, notably the basic body of the blade comprises this material. We may thus envisage embodiments in which, for only the lip 3 comprises the material.

only the heel 5 comprises the material,

the whole blade 1 comprises the material.

If necessary, all or part of the surface of the blade 1 may also be treated so as to modify it, for example by graphitization, plasma treatment, halogenation, ion implantation and/or deposition of a coating. This treatment makes it possible to reinforce the mechanical properties, wiping properties and/or wear resistance of the blade.

The wiper blade 1 may thus comprise a coating of the monolayer or multilayer type. The coating covers the basic body of the blade 1.

### EXAMPLE

An example of a formulation of material used for making a wiper blade 1 according to the invention is given here for purposes of illustration, but the invention is not in any way limited to this. The units are in phr (parts per hundred of rubber).

| Formulation | phr |
|---|---|
| Natural rubber | 100 |
| Kaolin | 120 |
| Wood fiber | 5 |
| Sunflower oil | 5 |
| Colza oil vulcanized with mineral sulfur | 10 |
| Diphenyl amine | 3 |
| Paraphenylenediamine | 4 |
| Titanium dioxide | 10 |
| Palmitic acid and stearic add | 0.8 |
| Zinc oxide | 7.5 |
| Vulcanizing system | 5.25 |
| (thiuram/thiazole/sulfenamide) | |

The vulcanization kinetics of this example of material was investigated. The measurements were performed according to standard ISO 3417. The results are as follows:

| Vulcanization properties | | |
|---|---|---|
| S′min. | 2.8 | dNm |
| S′max. | 17 | dNm |
| tₛ₂ | 1.5 | min |
| t₉₀ | 2.7 | mm |

| | |
|---|---|
| Vulcanization | 5 min at 165° C. |

Vulcanization takes 5 minutes at 165° C.

The Mooney viscosity of this material was also measured according to standard ISO 289. It is 54 Mooney units. From the viewpoint of application, the material can be used for an industrial process by molding or by extrusion with a mixing process with a short cycle time of the order of 4 to 8 min.

Tests were also carried out for testing the properties of this material, notably the mechanical properties.

The initial hardness of the material is 64 IRHD (international rubber hardness degrees). Hardness measurement was performed according to standards ISO 48 and ISO 188.

The measurements of tensile strength or tensile test were performed according to standard ISO 37 at 500 mm/min. The results are summarized in the following table:

| Initial properties | | |
|---|---|---|
| Tensile stress at 100% or Modulus 100% | 2.5 | MPa |
| Breaking strength | 10 | MPa |

| | |
|---|---|
| Elongation at rupture | 465% |

The elongation of the material subjected to elongation of 50% after 22 hours at 70° C. (50% elongation set) is 9%. It was measured according to standard ISO 2285.

The elasticity is 67% and is accompanied by a hysteresis effect of 28%. The elasticity was measured according to standard DIN53512 and the hysteresis effect was determined according to standard NFT 46002.

These properties are at the level of those of a conventional compound of nonbiosourced origin, notably based on carbon black as reinforcing filler, and nonbiosourced piasticizers.

Thus, in this example, the combination of two biosourced reinforcing fillers, kaolin and wood fiber, was used, replacing the conventional carbon black. This combination of reinforcing fillers was used together with a combination of two biosourced plasticizers, sunflower oil and colza oil. This double combination made it possible to obtain a material comprising less than 5 wt % of nonbiosourced additives that still has the mechanical properties necessary for use in wiper blade manufacture.

It should be noted that variant embodiments are of course possible and that the present invention is not limited just to wiper blades comprising the material of the formulation given as an example.

1. A wiper blade for a windshield wiper, at least part of said blade comprising:
a material based on natural rubber and at least one additive,
wherein said additive is at least one biosourced plasticizer; and
as the only rubber, said natural rubber in the vulcanized state, said vulcanized rubber being obtained by vulcanization of a nonfunctionalized natural rubber.

2. The wiper blade as claimed in claim 1, wherein the plasticizer is a biosourced oil.

3. The wiper blade as claimed in claim 2, wherein the difference between the solubility parameter of said biosourced oil and the solubility parameter of said natural rubber, measured in (cal/cm³)^{1/2}, is less than or equal to 2 (cal/cm³)^{1/2}.

4. The wiper blade as claimed in claim 3, wherein the solubility parameter of said biosourced oil is between 8.2 and 8.4 (cal/cm³)^{1/2}.

5. The wiper blade as claimed in claim 1, wherein said biosourced oil is selected from vegetable oils and/or fats, animal oils and/or fats, or a mixture thereof.

6. The wiper blade as claimed in claim 1, wherein said additive is moreover a biosourced reinforcing filler.

7. The wiper blade as claimed in claim 6, wherein said biosourced reinforcing filler is selected from a mineral filler, wood fibers, cellulose, diatoms, or a mixture thereof.

8. The wiper blade as claimed in claim 7, wherein said mineral filler is an aluminum silicate.

9. The wiper blade as claimed in claim 1, wherein more than 90 wt % of said material is of biosourced origin.

10. The wiper blade as claimed in claim 1, wherein said blade part comprising said material is a basic body of said blade.

11. The wiper blade as claimed in claim 1, wherein said additive is a biosourced protective agent against UV radiation.

12. The wiper blade as claimed in claim 1, wherein said additive is a nonbiosourced antioxidant and/or a nonbiosourced vulcanizing agent.

13. The wiper blade as claimed in claim 1, said blade comprising a single grade of natural rubber.

14. A windshield wiper comprising a wiper blade as claimed in claim 1.

15. A wiping system comprising a windshield wiper as claimed in claim 14.
